(19) United States
(12) Patent Application Publication
(10) Pub. No.: US 2026/0212638 A1
(43) Pub. Date: Jul. 23, 2026

(54) IMAGE PROCESSING METHOD, APPARATUS, ELECTRONIC DEVICE AND STORAGE MEDIUM

(71) Applicant: BEIJING CO WHEELS TECHNOLOGY CO., LTD., Beijing (CN)

(72) Inventors: Fei LI, Beijing (CN); Wenbo HOU, Beijing (CN); Peng JIA, Beijing (CN)

(21) Appl. No.: 19/078,027

(22) Filed: Mar. 12, 2025

(30) Foreign Application Priority Data
Jan. 23, 2025 (CN) 202510112194.2

(51) Int. Cl. G06V 10/44; G06T 5/77; G06T 5/92; G06V 10/42; G06V 10/60

(52) U.S. Cl. CPC G06V 10/44; G06T 5/77; G06T 5/92; G06V 10/42; G06V 10/60

(57) ABSTRACT

The present disclosure provides an image processing method, apparatus, electronic device and storage medium. The image processing method, including: preprocessing original image data to obtain first target image data; using an image conversion model, extracting local feature values and global feature values based on the first target image data, toning the local feature values and the global feature values, and acquiring target image data corresponding to the original image data based on the toned local feature values and the toned global feature values. The present disclosure may improve the accuracy of the first target image data by preprocessing; Processing using the image conversion model is more accurate and efficient than processing with the hardware. By extracting the local feature values and the global feature values, fine features and extensive features can be captured, making the image features more comprehensive.

The present disclosure claims priority to Chinese patents with Application No. 202510112194.2, entitled “IMAGE PROCESSING METHOD, APPARATUS, ELECTRONIC DEVICE AND STORAGE MEDIUM”, filed on Jan. 23, 2025, to China National Intellectual Property Administration, the entire contents of which are incorporated herein by reference.

### TECHNICAL FIELD

The present disclosure relates to the technical field of data processing, in particular to an image processing method, apparatus, electronic device and storage medium.

### BACKGROUND

ISP(Image Signal Processing) is a system for image processing, which aims to reconstruct RGB (Red, Green and Blue) images from an original image data captured by CMOS (Complementary Metal Oxide Semiconductor) sensors.

The traditional ISP algorithm is constructed manually, which depends on the deep understanding and complex adjustment of sensors. The hardware ISP pipeline is used for image processing, which has complicated processing process and low accuracy, and this limits its applicability in the fields of autonomous driving and robotics.

### SUMMARY

In view of the above problems, the embodiments of the present disclosure provides an image processing method, apparatus, electronic device and storage medium, which are used to solve the problems of complicated image processing process and low accuracy.

According to one aspect of the embodiments of the present disclosure, an image processing method is provided, and the method includes:
preprocessing original image data to obtain first target image data;
using an image conversion model, extracting local feature values and global feature values based on the first target image data, toning the local feature values and the global feature values, and acquiring target image data corresponding to the original image data based on the toned local feature values and the toned global feature values.

Optionally, preprocessing the original image data includes: acquiring a pixel value of each pixel in the original image data and a black level value corresponding to the original image data, and respectively subtracting the black level value from the pixel value of each pixel in the original image data.

Optionally, preprocessing the original image data includes: sampling pixels corresponding to a target color channel from the original image data, and filling rest unsampled pixels with filling values to obtain a sampling result corresponding to the target color channel.

Optionally, the image conversion model includes at least one attention module; extracting local feature values and global feature values based on the first target image data, toning the local feature values and the global feature values, and acquiring target image data corresponding to the original image data based on the toned local feature values and the toned global feature values, including: acquiring second target image data based on the first target image data; extracting local feature values and global feature values from the second target image data by using the at least one attention module, toning the local feature values and the global feature values, and acquiring third target image data based on the toned local feature values and the toned global feature values; acquiring the target image data corresponding to the original image data based on the third target image data.

Optionally, extracting local feature values and global feature values from the second target image data by using the at least one attention module, toning the local feature values and the global feature values, and acquiring third target image data based on the toned local feature values and the toned global feature values, including: taking the second target image data as an input of a first attention module; for each attention module, using the attention module to extract local feature values and global feature values from an input of each attention module, and toning the local feature values and global feature values, and obtaining an output of each attention module based on the toned local feature values and the toned global feature values, and adding the input of each attention module and the output of each attention module as an input of a next attention module; adding an input and an output of a last attention module as the third target image data.

Optionally, toning the local feature values and the global feature values includes: acquiring illuminance feature values corresponding to the input of each attention module; subtracting the illuminance feature values from the local feature values to obtain the toned feature values; subtracting the illuminance feature values from the global feature values to obtain the toned global feature values.

Optionally, obtaining an output of each attention module based on the toned local feature values and the toned global feature values includes: connecting the toned local feature values and the toned global feature values in series to obtain merged features; performing feature extraction and feature enhancement on the merged features to obtain fourth target image data; adding the fourth target image data with the input of each attention module as the output of each attention module.

According to another aspect of the embodiments of the present disclosure, an image conversion model is provided, and the image conversion model includes a processing module; the processing module, configured to extract local feature values and global feature values based on first target image data, toning the local feature values and the global feature values, and acquiring target image data corresponding to the original image data based on the toned local feature values and the toned global feature values; wherein the first target image data is obtained by preprocessing the original image data.

According to another aspect of the embodiments of the present disclosure, a model training method is provided, and the method includes: acquiring a training sample, wherein the training sample includes an original image data sample and a target image data sample corresponding to the original image data sample; training an image conversion model to be trained by using the training sample, calculating a plurality of loss functions of the image conversion model to be trained, and calculating a comprehensive loss function of the image conversion model to be trained based on the plurality of loss functions; obtaining a trained image conversion model when the comprehensive loss function meets a preset condition.

According to another aspect of the embodiments of the present disclosure, an image processing apparatus is provided, and the apparatus includes:
a preprocessing module, configured to preprocess original image data to obtain first target image data;
a conversion module, configured to use an image conversion model to extract local feature values and global feature values based on the first target image data, color the local feature values and the global feature values, and acquire target image data corresponding to the original image data based on the toned local feature values and the toned global feature values.

Optionally, the preprocessing module includes: a first processing unit, configured to acquire a pixel value of each pixel in the original image data and a black level value corresponding to the original image data, and respectively subtract the black level value from the pixel value of each pixel in the original image data.

Optionally, the preprocessing module includes: a second processing unit, configured to sample pixels corresponding to a target color channel from the original image data, and fill rest unsampled pixels with filling values to obtain a sampling result corresponding to the target color channel.

Optionally, the image conversion model includes at least one attention module; the conversion module is specifically configured to acquire second target image data based on the first target image data; extract local feature values and global feature values from the second target image data by using the at least one attention module, color the local feature values and the global feature values, and acquire third target image data based on the toned local feature values and the toned global feature values; acquire the target image data corresponding to the original image data based on the third target image data.

Optionally, the conversion module is specifically configured to take the second target image data as an input of a first attention module; for each attention module, using the attention module to extract local feature values and global feature values from an input of each attention module, and toning the local feature values and global feature values, and obtaining an output of each attention module based on the toned local feature values and the toned global feature values, and adding the input of each attention module and the output of each attention module as an input of a next attention module; adding an input and an output of a last attention module as the third target image data.

Optionally, the conversion module is specifically configured to acquire illuminance feature values corresponding to the input of each attention module; subtract the illuminance feature values from the local feature values to obtain the toned feature values; subtract the illuminance feature values from the global feature values to obtain the toned global feature values.

Optionally, the conversion module is specifically configured to connect the toned local feature values and the toned global feature values in series to obtain merged features; perform feature extraction and feature enhancement on the merged features to obtain fourth target image data; add the fourth target image data with the input of each attention module as the output of each attention module.

According to another aspect of the embodiments of the present disclosure, an electronic device is provided, and the electronic device includes a processor and a computer-readable storage medium, wherein a computer program is stored on the computer-readable storage medium; when the computer program is executed by the processor, it causes the processor to execute the image processing method according to any one of above descriptions or the model training method according to above description.

According to another aspect of the embodiments of the present disclosure, a computer-readable storage medium is provided, wherein a computer program is stored on the computer-readable storage medium, which, when executed by a processor, causes the processor to execute the image processing method according to any one of above descriptions or the model training method according to above description.

In the embodiments of the present disclosure, firstly, the original image data is preprocessed to obtain the first target image data, and the accuracy of the first target image data can be improved by preprocessing; Then, the image conversion model is used to analyze based on the first image data. The processing of the deep learning model is more accurate and efficient than that of the hardware. By extracting the local feature values and the global feature values, fine features and extensive features can be captured, making the image features more comprehensive. By toning the local feature values and the global feature values, the problem of uneven exposure of the image can be solved, so the obtained target image data is more accurate.

The above description is only an overview of the technical solution of the present disclosure. In order to understand the technical means of the present disclosure more clearly, it can be implemented according to the contents of the specification, and in order to make the above and other purposes, features and advantages of the present disclosure more obvious and understandable, the following is specific embodiments of the present disclosure.

### BRIEF DESCRIPTION OF THE DRAWINGS

In order to explain the technical solution of the embodiments of the present disclosure more clearly, the appended drawings needed to be used in the description of the embodiments of the present disclosure will be briefly introduced below. Apparently, the appended drawings in the following description are only some drawings of the present disclosure. For persons skilled in the art, other drawings can be obtained according to these drawings without expenditure of creative labor.

FIG. 1 is a flowchart of an image processing method according to an embodiment of the present disclosure;

FIG. 2 is a schematic diagram of an original image data according to an embodiment of the present disclosure;

FIG. 3 is a schematic diagram of a four-channel division in the related art;

FIG. 4 is a schematic diagram of a three-channel division according to an embodiment of the present disclosure;

FIG. 5 is a schematic structural diagram of an image conversion model according to an embodiment of the present disclosure;

FIG. 6 is a schematic structural diagram of an RMFA module according to an embodiment of the present disclosure;

FIG. 7 is a flowchart of a model training according to an embodiment of the present disclosure;

FIG. 8 is a structural block diagram of an image processing apparatus according to an embodiment of the present disclosure;

FIG. 9 is a structural block diagram of an electronic device according to an embodiment of the present disclosure;

FIG. 10 is a structural block diagram of a computer-readable storage medium according to an embodiment of the present disclosure.

### DETAILED DESCRIPTION OF THE EMBODIMENTS

In order to make the purpose, technical solution and advantages of the embodiment of the present disclosure clearer, the technical solution in the embodiments of the present disclosure will be described clearly and completely with the appended drawings. Apparently, the described embodiments are a part of the embodiments of the present disclosure, but not the whole embodiment. Based on the embodiments in the present disclosure, all other embodiments obtained by persons skilled in the art without expenditure of creative labor belong to the protection scope of the present disclosure.

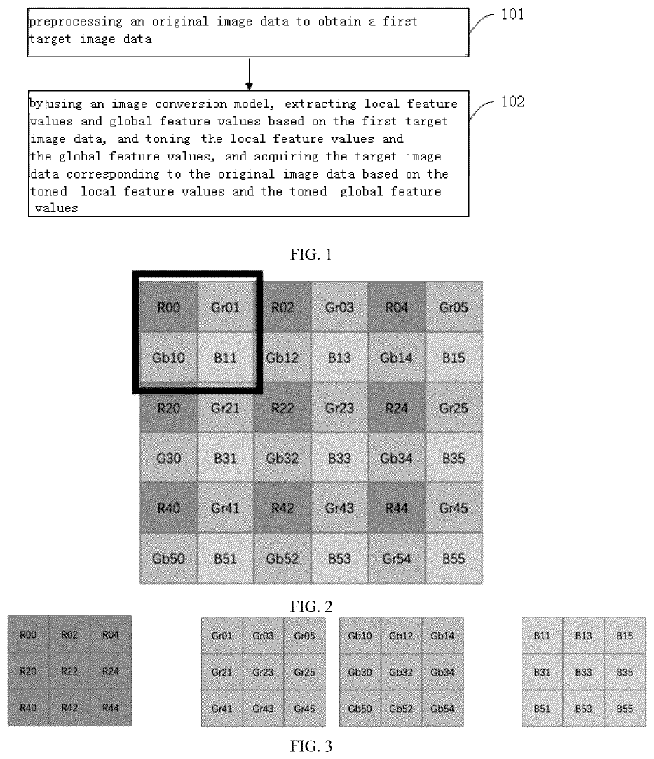

Referring to FIG. 1, a flowchart of an image processing method according to an embodiment of the present disclosure is shown.

As shown in FIG. 1, the image processing method may include the following steps.

Step 101: preprocessing an original image data to obtain a first target image data.

The original image data refers to the unprocessed image data captured directly from an camera image sensor. When the camera takes an image, the image sensor will capture light and convert it into electrical signals, and the electrical signals are then converted into digital signals and saved in Raw (Raw, unprocessed) format, and the Raw format contains the original pixel information captured from the image sensor without image processing or color coding.

In the embodiment of the present disclosure, considering the specific features the original image data, such as a black level, a CFA (Color Filter Array), etc., if it is not handled properly, it may have a negative impact on the texture and color. Therefore, the original image data can be preprocessed and the first target image data can be obtained after preprocessing.

The influence of the black level on color is more obvious especially in dark scenes, which will lead to color deviation in the dark scenes. In an electronic device, the sensor will generate electrons even in the absence of light, and these electrons will also be collected and read by the sensor. In order to solve this problem, the image sensor adopts optical black pixels to reduce the influence of the black level, and adds a fixed reference level to the final output. However, the reference level may introduce color shift, especially in dark scenes. In order to solve the above problems, in the process of preprocessing the original image data, the black level of the original image data can be corrected to reduce the color shift in dark scenes.

Illustratively, the process of preprocessing the original image data may include acquiring a pixel value of each pixel in the original image data and black level values corresponding to the original image data, and subtracting the black level values from the pixel value of each pixel in the original image data respectively. Wherein, the original image data includes the pixel value of each pixel, the black level value corresponding to the original image data refers to the value corresponding to the image field of the black level value corresponding to the original image data, and the black level value corresponding to the original image data can be obtained by the image sensor. The processing progress of this method is simple and can reduce the color shift in dark scenes.

Different CFAs have different sampling rates, and completely dividing according to four channels will lead to a loss of important information of the image. In order to solve the above problems, in the process of preprocessing the original image data, the original image data can be divided into three channels to solve the difference of sampling rate and ensure that the complete original information is preserved.

FIG. 2 is a schematic diagram of an original image data according to an embodiment of the present disclosure. As shown in FIG. 2, in the original image data, Bayer mode includes four channels: R, Gr, Gb and B.

FIG. 3 is a schematic diagram of a four-channel division in the related art. As shown in FIG. 3, in the related art, each channel (R, Gr, Gb, B) in Bayer mode is divided and stacked as an input of a neural network. However, this method has some defects.

First, each channel of the original image data has a different sampling rate. In Bayer mode, the sampling rate of the green channel is twice that of the red channel and the blue channel, as shown in FIG. 2, which means that the green channel contains more information. In addition, the green channel usually shows better sensitivity than the red channel and the blue channel, which leads to more information, especially high-frequency information, and higher signal-to-noise ratio. Therefore, the green channel has more advantages in recovering high-frequency information and should be handled with caution.

Secondly, when using four-channel mode, high-frequency information will be lost. In this mode, the green channel is further divided into a Gr channel and a Gb channel. This extra division corresponds to downsampling the green channel, resulting in the loss of high-frequency information in the original image data. The data size in four-channel mode is half of the original size, as shown in FIG. 3. For example, 3×3pixels of four-channel data correspond to 5×5 pixels in the original data. This spatial frequency change makes it difficult for the network to accurately extract and reconstruct the lost high-frequency information in the original 5×5 pixels. In addition, dislocation is also a problem that needs to be considered. As shown by the pixels selected in the box in FIG. 2, the pixels in the same position in the four channels actually correspond to the 2×2 neighborhood in the original image data, which may lead to blurring and have a negative impact on the reconstruction quality.

In order to solve the above problems, a three-channel division method is proposed in the embodiment of the present disclosure.

Illustratively, the process of preprocessing the original image data includes: sampling the pixels corresponding to the target color channel from the original image data, and filling the rest unsampled pixels with filling values to obtain a sampling result corresponding to the target color channel. Wherein, the target color channel can be multiple color channels, and each color channel can be sampled and filled separately. For example, the target color channel can be three color channels of R, G and B, but it can also be color channels of other number, which is not limited in this embodiment.

Taking the target color channel as three color channels as an example, for each of the three color channels, the pixels corresponding to the color channel are sampled from the original image data, and the rest unsampled pixels are filled with filling values to obtain sampling results corresponding to the color channels, and the sampling results corresponding to each color channel are stacked. In this way, the original information is preserved by keeping the G channel undivided, and the dislocation is avoided by the channel division with the same pixel position, thus solving the problem of information loss caused by the difference of sampling rate.

The above-mentioned filling value can be a preset value according to actual experience and demand, and this embodiment does not limit this. For example, the filling value can be 1 and so on.

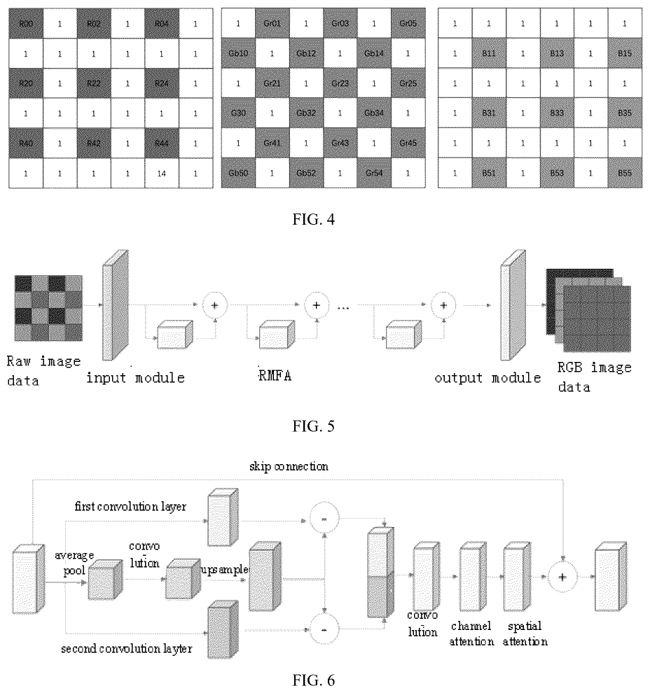

FIG. 4 is a schematic diagram of a three-channel division according to an embodiment of the present disclosure. As shown in FIG. 4, the original image data is divided into three channels (R, G, B), each channel keeps the size of the original data, and for the non-sampled pixels, it is filled with 1. As a result, the sampling rate of G channel remains unchanged, and the high-frequency texture information is preserved as much as possible, which is more conducive to the accurate reconstruction of high-frequency information by the network.

In the embodiment of the present disclosure, in the process of preprocessing t original image data, the above-mentioned black level correction method and three-channel division method can also be used for processing. Illustratively, the process of preprocessing the original image data includes: acquiring the pixel value of each pixel in the original image data and the black level value corresponding to the original image data, and subtracting the black level value from the pixel value of each pixel in the original image data; Sampling the pixels corresponding to the target color channel from the original image data, and filling the rest unsampled pixels with filling values to obtain a sampling result corresponding to the target color channel.

Step 102: using an image conversion model, extracting local feature values and global feature values based on the first target image data, and toning the local feature values and the global feature values, and acquiring the target image data corresponding to the original image data based on the toned local feature values and the toned global feature values.

In the embodiment of the present disclosure, considering that the deep learning model has the advantages of high accuracy and high efficiency, the deep learning algorithm can be adopted to improve the performance of the ISP (Image Signal Processing). One way is image enhancement algorithm, but the image enhancement algorithm focuses on improving specific aspects of image quality by post-ISP processing of the target image, such as denoising, high dynamic range images and super resolution. The other way is network inline method, and the paradigmatic network inline method uses neural network to replace some sub-modules in the traditional hardware ISP pipeline, such as demosaicing, which requires frequent data exchange between different hardware. In order to solve the above problems, the embodiment of the present disclosure proposes to replace ISP system with end-to-end neural network, and generate the target image with the original image data as input, which shows that it has better effect in enhancing image quality and perceptual performance. Therefore, in the embodiment of the present disclosure, the first target image data is processed by using the image conversion model, so as to obtain the target image data corresponding to the original image data.

Relevant features that can characterize the resolution, contrast, color and brightness of the first target image data are considered. Wherein, the resolution depends more on local feature values, while color and brightness depend more on global feature values, which affect the contrast of the whole image, while local feature values affect the contrast of smaller areas. Therefore, in order to achieve high-quality image reconstruction, the image transformation model needs to extract local feature values and global feature values based on the first target image data, so as to capture features of various ranges and enhance the overall image quality in the reconstruction process. The local feature values retain detailed details, while the global feature values capture wider features, thus forming a more comprehensive image texture information representation.

Considering the uneven exposure of the first target image data, the contrast and brightness will be adversely affected. Therefore, in order to solve the problem of uneven exposure, the image conversion model carries out toning on the extracted features, which involves toning on the local feature values and the global feature values, so as to achieve higher contrast, maintain consistent brightness and color, and remove the interference of uneven exposure in the first target image data.

Finally, the image conversion model performs subsequent processing based on the toned local feature values and the toned global feature values, thereby obtaining the target image data corresponding to the original image data. Wherein, the target image data can be image data of any applicable format such as RGB image data, and this embodiment does not limit this.

In the embodiment of the present disclosure, firstly, the original image data is preprocessed to obtain the first target image data, and the accuracy of the first target image data can be improved by preprocessing; Then, the image conversion model is used to analyze based on the first image data. The processing of the deep learning model is more accurate and efficient than that of the hardware. By extracting the local feature values and the global feature values, fine features and extensive features can be captured, making the image features more comprehensive. By toning the local feature values and the global feature values, the problem of uneven exposure of the image can be solved, so the obtained target image data is more accurate.

In the embodiment of the present disclosure, the image conversion model may include a processing module; The processing module is used to extract local feature values and global feature values based on the first target image data, toning the local feature values and the global feature values, and acquiring target image data corresponding to the original image data based on the toned local feature values and the toned global feature values; Wherein the first target image data is obtained by preprocessing the original image data.

Illustratively, the image conversion model includes at least one attention module, that is, the above processing module includes at least one attention module. Using an image conversion model, extracting local feature values and global feature values based on the first target image data, toning the local feature values and the global feature values, and acquiring target image data corresponding to the original image data based on the toned local feature values and the toned global feature values, including: acquiring second target image data based on the first target image data; extracting local feature values and global feature values from the second target image data by using the at least one attention module, toning the local feature values and the global feature values, and acquiring third target image data based on the toned local feature values and the toned global feature values; acquiring target image data corresponding to the original image data based on the third target image data. Multiple feature extraction and analysis by at least one attention module can further improve the accuracy of image processing.

The attention module can be an attention module with any applicable structure such as a residual multi-frequency attention module.

Next, the image conversion model is introduced in detail.

FIG. 5 is a schematic structural diagram of an image conversion model according to an embodiment of the present disclosure.

As shown in FIG. 5, the image conversion model is divided into three main parts: an input module, stacked at least one RMFA (Residual Multi-frequency Attention) module and an output module. Accordingly, the input module, the stacked at least one RMFA module and the output module are located in the above processing module.

The input of the input module is Raw image data, that is, the first target image data obtained by preprocessing the original image data. The input module receives the image data with the size of 256×256×3 and expands the depth from 3 to the uniform width required by the convolution layer. In the input module, at least one convolution layer is stacked to perform convolution operation on the input Raw image data, and the size of the convolution kernel can be 3×3. It should be noted that the input module can also use tanh function (hyperbolic tangent function) to map the result to the interval (−1,1). Therefore, the second target image data can be acquired in the input module based on the first target image data, and the output of the input module is the second target image data.

The input of the first RMFA module is the second target image data, the output and input of the previous RMFA module are added as the input of the next attention module, and the input and output of the last attention module are added as the input of the output module. Using the stacked at least one RMFA module, extracting local feature values and global feature values from the second target image data, toning the local feature values and the global feature values, and acquiring the third target image data based on the toned local feature values and the toned global feature values.

The input of the output module is the third target image data, and the convolution layer and sigmoid activation function are used in the output module to process the third target image data, so as to obtain RGB image data corresponding to the original image data based on the third target image data, and the output of the output module is RGB image data, that is, the above target image data.

Illustratively, the process of extracting local feature values and global feature values from the second target image data by using the at least one attention module, toning the local feature values and the global feature values, and acquiring the third target image data based on the toned local feature values and the toned global feature values includes: for each attention module, the attention module is used to extract local feature values and global feature values from an input of each attention module, and the local feature values and global feature values are toned, and an output of each attention module is obtained based on the toned local feature values and global feature values, and the input of each attention module and the output of each attention module are added as the input of the next attention module; adding the input and output of the last attention module as the third target image data. In this way, adding the input and output can prevent performance degradation.

In the embodiment of the present disclosure, a texture module can be set in t RMFA module, and the texture module includes a first convolution layer and a second convolution layer, and the size of the convolution core of the first convolution layer is smaller than that of the second convolution layer. Therefore, the process of extracting local feature values and global feature values from the input of each attention module can include: extracting local feature values from the input of each attention module by using the first convolution layer; extracting global feature values from the input of each attention module by using the second convolution layer.

The texture module consists of two branches.

A high-frequency information extraction branch (that is, the first convolution layer): this branch is responsible for extracting high-frequency information from input data. It uses a smaller 1×1 convolution kernel to capture the subtle details and subtle changes in the image. By using a smaller convolution kernel, the network can effectively extract high-frequency texture and keep fine details in the reconstructed image.

A low-frequency information extraction branch (that is, the second convolution layer): this branch is responsible for extracting low-frequency information from input data. It uses a larger 3×3 convolution kernel to capture a wider range of features and smooth the image. By a relatively large convolution kernel, the network can capture low-frequency textures, such as overall color and tone changes, and ensure that the reconstructed image remains visually beautiful.

By combining these two branches in the texture module, it aims to capture various textures and enhance the overall image quality in the reconstruction process. High-frequency branches retain detailed details, while low-frequency branches capture broader features, thus forming a more comprehensive image texture information representation.

In the embodiment of the present disclosure, a toned module (which can be called a toned module) can be set in the RMFA module, and the process of toning the local feature values and the global feature values by the toned module can include: acquiring the illumination feature values corresponding to the input of each attention module; subtracting the illuminance feature values from the local feature values to obtain local feature values after toning; subtracting the illuminance feature values from the global feature values to obtain the global feature values after toning.

It should be noted that the size of local feature values, global feature values and illumination feature values are the same. In the process of subtracting the illumination feature values from the local feature values, the local feature value of any position is subtracted from the corresponding illumination feature value of the same position. In the process of subtracting the illumination feature values from the global feature values, the global feature value of any position is subtracted from the corresponding illumination feature value of the same position. For example, the local feature value at position (1,1) is subtracted from the illuminance feature value at position (1,1), and the global feature value at position (1,1) is subtracted from the illuminance feature value at position (1,1), and so on.

In order to generate the target image data from the original image data, the network needs to perform toning, which involves toning of the image within the range of local feature values and global feature values to achieve higher contrast while maintaining consistent brightness and color. At present, the methods based on neural network usually achieve this implicitly by minimizing specific structural losses. However, these methods often ignore the uneven exposure features of the original image data, which may hinder the learning process.

The original image data is usually captured by automatic exposure to obtain appropriate brightness. However, the automatic exposure strategy may only cover some areas of the image correctly, resulting in overexposure or underexposure in other areas. Because this inhomogeneity will change with the change of ambient illumination, different tone distributions will be produced in the original image data. When learning the tone function, the network needs to lighten the underexposed areas locally, darken the overexposed areas and adjust the tone globally to adapt to the output. In essence, the network needs to map this diversity to a relatively consistent range, which can be regarded as a many-to-one mapping. However, this significantly increases the difficulty and complexity of the learning process.

In the embodiment of the present disclosure, the aim is to simplify this problem by directly dealing with uneven exposure, and change this relationship from many-to-one mapping to one-to-one mapping.

According to Retinex (Retinal Cortex) theory, the image can be decomposed into reflectance component and illumination feature component:

$$Retinex ( I ) = Reflectance ( r ) \cdot Illumination ( S )$$

Retinex(I) represents an original image data, Reflectance (r) represents a reflectance, and Illumination(S) represents an illumination feature value.

The reflectance component represents the inherent features of the image and remains consistent under all illumination conditions, while the illumination feature component represents the variation of illumination. Therefore, by extracting consistent reflectance, uneven exposure can be removed, thus simplifying the toning function to one-to-one mapping.

Based on this, a toned module is proposed, and a pool-convolution structure i introduced to estimate the illumination feature values. The structure downsamples the input data by the pooling layer, and then applies the convolution layer. The initial pool layer expands a receptive field of the subsequent convolution layer, and this unit can be reused to extract more accurate features. The feature is then upsampled to its original size. In order to estimate the reflectance, the estimated illuminance feature values can be subtracted from the output of the texture module, and the final output can be regarded as the reflectance. By explicitly considering the features of uneven exposure and designing the toned module, it aims to improve the learning process and enhance the network's ability to perform effective toning when generating target image data from original image data.

In the embodiment of the present disclosure, a post-processing module can be set in the RMFA module, and the process of obtaining the output of each attention module by the post-processing module based on the toned local feature values and the toned global feature values may include: connecting the toned local feature values and the toned global feature values in series to obtain merged features; performing feature extraction and feature enhancement on the merged features to obtain fourth target image data; adding the fourth target image data with the input of each attention module as the output of each attention module.

In the post-processing module, the outputs of the toned module are first connected in series, then the convolution layer is used for feature extraction, and the number of feature maps is mapped to the original depth and width. After each convolution operation, a ReLU activation function can be applied, and then a channel attention module and a space attention module are added in turn for feature enhancement. Finally, a skip connection is introduced to add the input data to prevent performance degradation.

As a multifunctional building block, the RMFA module can be seamlessly integrated into various architectures, thus enhancing the flexibility and adaptability of the model.

FIG. 6 is a schematic structural diagram of an RMFA module according to an embodiment of the present disclosure. As shown in FIG. 6, in the RMFA module, for an input of each attention module, a first convolution layer (Conv1×1) is used to perform convolution operation to obtain local feature values, and a second convolution layer (Conv3×3) is used to perform convolution operation to obtain global feature values, and an average pool layer (AvgPool), a convolution layer (Conv3×3) and upsample are used to process in turn to obtain illumination feature values. Then subtract the illumination feature values from the local feature values to get the toned local feature values, and subtract the illumination feature values from the global feature values to get the toned global feature values. After the toned local feature values and the toned global feature values are connected in series, they are processed by a convolution layer (Conv3×3), a channel attention module, a spatial attention module in turn, and then a skip connection is introduced to add the result with the input of each attention module, so as to get the output of each attention module.

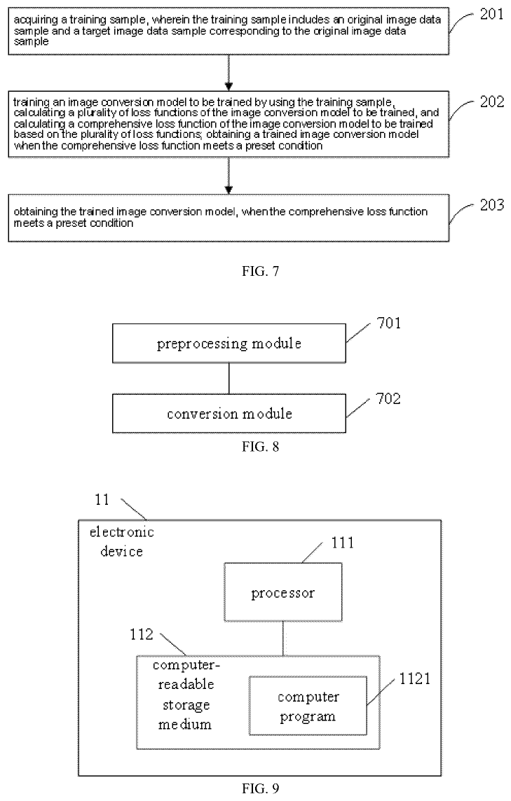

FIG. 7 is a flowchart of a model training according to an embodiment of the present disclosure.

As shown in FIG. 7, a model training method may include the following steps.

Step 201: acquiring a training sample, wherein the training sample includes an original image data sample and a target image data sample corresponding to the original image data sample.

In the embodiment of the present disclosure, the original image data and the target image data pairs can be collected based on any applicable open source data set. In the implementation, because the collected original image data and target image data are not perfectly aligned, dense matching algorithm based on deep learning can be used to align the images. It should be noted that the alignment operation is performed on the target image data, while the original image data from the image sensor remains unchanged, retaining the original value read from the sensor. Pixels of the required size are extracted from the original image data and the target image data pairs after alignment, respectively, and used as the original image data sample and the target image data sample pairs. In order to create training sample data sets and test sample data sets, the above data sets can also be divided according to a set proportion to ensure the stability of evaluation.

Step 202: training an image conversion model to be trained by using the training sample, calculating a plurality of loss functions of the image conversion model to be trained, and calculating a comprehensive loss function of the image conversion model to be trained based on the plurality of loss functions; obtaining a trained image conversion model when the comprehensive loss function meets a preset condition.

In the process of training the image conversion model to be trained with training samples, the original image data samples are used as the input of the image conversion model to be trained, and the output of the image conversion model to be trained is prediction target image data corresponding to the original image data samples. Based on the target image data samples and the prediction target image data, the loss function of the image conversion model to be trained can be calculated.

In the embodiment of the present disclosure, the loss function used for training the image conversion model is a linear combination of multiple loss functions, and the comprehensive loss function of the image conversion model is obtained by weighted summation calculation of the multiple loss functions.

Illustratively, the above loss function may include, but is not limited to, L1 los perceptual loss based on four-layer VGG16 (Visual Geometry Group), SSIM (Structural Similarity Index Measurement) loss, color loss, and so on.

Accordingly, the comprehensive loss function is defined as follows:

$$Loss = θ Ll 1 + η Lvgg + λ Lssim + γ Lcolor$$

Wherein, Loss represents a comprehensive loss function, Ll1 represents a L1 loss, Lvgg represents a perceptual loss, Lssim represents a SSIM loss, Lcolor represents a color loss, θ represents a weight of the L1 loss, η represents a weight of the perceptual loss, λ represents a weight of the SSIM loss, and γ represents a weight of the color loss.

The weight of each loss can be set according to the actual demand, which is not limited in this embodiment. For example, the weight of L1 loss can be set to maximum, such as 1, and so on.

Step 203: obtaining the trained image conversion model, when the comprehensive loss function meets a preset condition.

When the comprehensive loss function does not meet the preset condition, the parameters of the image conversion model are adjusted to continue training; When the comprehensive loss function meets the preset condition, it can be determined that the training is completed, and the trained image conversion model can be obtained. Wherein, the preset condition can be that the comprehensive loss function is less than a preset threshold and etc.

In the training process, suitable batch size, initial learning rate, optimized rounds and scheduling mode (such as cosine annealing scheduling) can be selected to process according to actual needs, which is not limited in this embodiment.

In order to verify the effectiveness of the three-channel division method, by comparing the three-channel division method with the four-channel division method, it is concluded that the performance of the three-channel division method is better than that of the four-channel division method, which improves the signal-to-noise ratio. In the output image of four-channel division, there are obvious artifacts such as moire, blur, sawtooth effect and false color. However, these artifacts are almost invisible in the output of the image conversion model in the embodiment of the present disclosure, which shows the effectiveness of the three-channel division method.

In order to verify the effectiveness of the toned module, by comparing the image conversion model with the toned module and the image conversion model without the toned module, it is concluded that the output of the image conversion model with the toned module shows better contrast and clarity, and the brightness is accurately reconstructed, reaching a level similar to a target photo.

The image conversion model in the embodiment of the present disclosure has the flexibility to adapt to the computational complexity by adjusting the number of RMFA modules. This makes it possible to design networks of different sizes to meet the required running time, task performance and calculation budget.

Referring to FIG. 8, a structural block diagram of an image processing apparatus according to an embodiment of the present disclosure is shown.

As shown in FIG. 8, the image processing apparatus may include the following modules.
A preprocessing module 701, configured to preprocess original image data to obtain first target image data;
A conversion module 702, configured to use an image conversion model to extract local feature values and global feature values based on the first target image data, color the local feature values and the global feature values, and acquire target image data corresponding to the original image data based on the toned local feature values and the toned global feature values.

Optionally, the preprocessing module 701 includes a first processing unit, configured to acquire a pixel value of each pixel in the original image data and a black level value corresponding to the original image data, and respectively subtract the black level value from the pixel value of each pixel in the original image data.

Optionally, the preprocessing module 701 includes a second processing unit, configured to sample pixels corresponding to a target color channel from the original image data, and fill rest unsampled pixels with filling values to obtain a sampling result corresponding to the target color channel.

Optionally, the image conversion model includes at least one attention module; the conversion module 702 is specifically configured to acquire second target image data based on the first target image data; extract local feature values and global feature values from the second target image data by using the at least one attention module, color the local feature values and the global feature values, and acquire third target image data based on the toned local feature values and the toned global feature values; acquire the target image data corresponding to the original image data based on the third target image data.

Optionally, the conversion module 702 is specifically configured to take the second target image data as an input of a first attention module; for each attention module, using the attention module to extract local feature values and global feature values from an input of each attention module, and toning the local feature values and global feature values, and obtaining an output of each attention module based on the toned local feature values and the toned global feature values, and adding the input of each attention module and the output of each attention module as an input of a next attention module; adding an input and an output of a last attention module as the third target image data.

Optionally, the conversion module 702 is specifically configured to acquire illuminance feature values corresponding to the input of each attention module; subtract the illuminance feature values from the local feature values to obtain the toned feature values; subtract the illuminance feature values from the global feature values to obtain the toned global feature values.

Optionally, the conversion module 702 is specifically configured to connect the toned local feature values and the toned global feature values in series to obtain a merged feature; Performing feature extraction and feature enhancement on the merged features to obtain fourth target image data; Adding the fourth target image data with the input of each attention module as the output of each attention module.

In the embodiments of the present disclosure, firstly, the original image data is preprocessed to obtain the first target image data, and the accuracy of the first target image data can be improved by preprocessing; Then, the image conversion model is used to analyze based on the first image data. The processing of the deep learning model is more accurate and efficient than that of the hardware. By extracting the local feature values and the global feature values, fine features and extensive features can be captured, making the image features more comprehensive. By toning the local feature values and the global feature values, the problem of uneven exposure of the image can be solved, so the obtained target image data is more accurate.

As for the apparatus embodiment, because it is basically similar to the method embodiments, the description is relatively simple, and the relevant points can only be found in part of the description of the method embodiments.

In the embodiment of the present disclosure, the present disclosure also provides an electronic device. The electronic device may include a processor and a computer-readable storage medium, wherein a computer program is stored on the computer-readable storage medium; When the computer program is executed by the processor, it causes the processor to perform the image processing method of any of the above embodiments, or to perform the model training method of the above embodiments.

Referring to FIG. 9, a structural block diagram of an electronic device according to an embodiment of the present disclosure is shown. As shown in FIG. 9, a electronic device 11 includes a processor 111 and a computer-readable storage medium 112, on which a computer program 1121 is stored.

The processor 111 is used to execute the computer program 1121 stored on the computer-readable storage medium 112. When the processor 111 executes the computer program 1121, it can realize the image processing method of any of the above embodiments, or execute the model training method of the above embodiments, and can achieve the same technical effect. In order to avoid repetition, it will not be repeated here.

The aforementioned processor 111 may include, but is not limited to, a Central Processing Unit (CPU), a Network Processor (NP), a Digital Signal Processing (DSP), an Application Specific Integrated Circuit (ASIC), a Field-Programmable Gate Array (FPGA) or other programmable logic devices, discrete gates or transistor logic devices, discrete hardware components, and so on.

The computer-readable storage medium 112 mentioned above may include, but is not limited to, a Read Only Memory (ROM), a Random Access Memory (RAM), a Compact Disc Read Only Memory (CD-ROM), an Electronic Erasable Programmable Read Only Memory (EEPROM), a hard disk, a floppy disk, a flash memory, and so on.

In an embodiment of the present disclosure, a computer-readable storage medium is also provided, and a computer program is stored on the computer-readable storage medium, and the computer program can be executed by a processor of an electronic device, and when the computer program is executed by the processor, the processor is caused to execute the image processing method according to any embodiment.

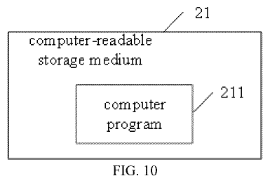

Referring to FIG. 10, a structural block diagram of a computer-readable storage medium according to an embodiment of the present disclosure is shown. As shown in FIG. 10, a computer program 211 is stored on a computer-readable storage medium 21. When the computer program 211 is executed by a processor, it causes the processor to execute the image processing method as described in any embodiment or the model training method as described in the above embodiment, and the same technical effect can be achieved. In order to avoid repetition, it will not be repeated here.

The various embodiments in this specification are interrelated, and each embodiment is described in a progressive way. Each embodiment focuses on the differences from other embodiments, and the same or similar parts between the various embodiments can only be referred to each other.

It should be pointed out that all the actions of obtaining signals, information or data in the present disclosure are carried out under the premise of complying with the corresponding data protection laws and policies in the locality and obtaining authorization from the corresponding device owner.

It should be noted that in this paper, relational terms such as first and second are only used to distinguish one entity or operation from another entity or operation, and do not necessarily require or imply that there is any such actual relationship or order between these entities or operations. Moreover, the terms “comprising”, “including” or any other variation thereof are intended to cover non-exclusive inclusion, so that a process, method, article or terminal device including a series of elements includes not only those elements, but also other elements not explicitly listed, or elements inherent to such process, method, article or terminal device. Without more restrictions, the element defined by the phrase “including one” does not exclude that there are other identical elements in the process, method, article or terminal equipment including the element.

By the description of the above embodiments, those skilled in the art can clearly understand that the methods of the above embodiments can be realized by means of software and necessary general hardware platform, and of course they can also be realized by hardware, but in many cases, the former is the better embodiment. Based on this understanding, the technical solution of the present disclosure can be embodied in the form of a software product, which is stored in a storage medium and includes several instructions to make a computer device (which can be a personal computer, a server, a network device, etc.) execute all or part of the steps of the method described in various embodiments of the present disclosure.

The embodiments of the present disclosure have been described above with the appended drawings, but the present disclosure is not limited to the above specific embodiments, which are only schematic, not restrictive. Under the inspiration of the present disclosure, persons skilled in the art can make many forms without departing from the purpose of the present disclosure and the scope protected by the claims, which are all within the protection of the present disclosure.

Those skilled in the art can realize that the units and algorithm steps of various examples described in connection with the embodiments disclosed in the embodiments of the present disclosure can be realized by electronic hardware, or a combination of computer software and electronic hardware. Whether these functions are implemented in hardware or software depends on the specific application and design constraints of the technical solution. Those skilled in the art can use different methods to realize the described functions for each specific application, but this implementation should not be considered beyond the scope of the present disclosure.

In the embodiments provided by the present disclosure, it should be understood that the disclosed devices and methods can be realized in other ways. For example, the device embodiment described above is only schematic. For example, the division of the units is only a logical function division. In actual implementation, there may be other division methods, such as multiple units or components can be combined or integrated into another system, or some features can be ignored or not implemented. On the other hand, the mutual coupling or direct coupling or communication connection shown or discussed can be indirect coupling or communication connection by some interfaces, devices or units, which can be electrical, mechanical or other forms.

The units described as separate components may or may not be physically separated, and the components displayed as units may or may not be physical units, that is, they may be located in one place or distributed to multiple network units. Some or all of the units can be selected according to actual needs to achieve the purpose of the embodiments.

In addition, each functional unit in each embodiment of the present disclosure can be integrated into one processing unit, or each unit can exist physically alone, or two or more units can be integrated into one unit.

The above is only the specific implementation of the present disclosure, but the protection scope of the present disclosure is not limited to this. Any person skilled in the art can easily think of changes or substitutions within the technical scope disclosed in the present disclosure, which should be covered by the present disclosure. In summary, the contents of this specification should not be construed as limiting the present disclosure.

1. An image processing method, comprising:
preprocessing original image data to obtain first target image data; and
by using an image conversion model, extracting local feature values and global feature values based on the first target image data, toning the local feature values and the global feature values, and acquiring target image data corresponding to the original image data based on the toned local feature values and the toned global feature values.

2. The method according to claim 1, wherein preprocessing the original image data comprises:
acquiring a pixel value of each pixel in the original image data and a black level value corresponding to the original image data, and respectively subtracting the black level value from the pixel value of each pixel in the original image data.

3. The method according to claim 1, wherein preprocessing the original image data comprises:
sampling pixels corresponding to a target color channel from the original image data, and filling rest unsampled pixels with filling values to obtain a sampling result corresponding to the target color channel.

4. The method according to claim 1, wherein the image conversion model comprises at least one attention module; and the extracting local feature values and global feature values based on the first target image data, toning the local feature values and the global feature values, and acquiring target image data corresponding to the original image data based on the toned local feature values and the toned global feature values, comprise:
acquiring second target image data based on the first target image data;
by using the at least one attention module, extracting local feature values and global feature values from the second target image data, toning the local feature values and the global feature values, and acquiring third target image data based on the toned local feature values and the toned global feature values; and
acquiring the target image data corresponding to the original image data based on the third target image data.

5. The method according to claim 4, wherein by using the at least one attention module, extracting local feature values and global feature values from the second target image data, toning the local feature values and the global feature values, and acquiring third target image data based on the toned local feature values and the toned global feature values, comprise:
taking the second target image data as an input of a first attention module;
for each attention module, by using the attention module, extracting local feature values and global feature values from an input of each attention module, and toning the local feature values and global feature values, and acquiring an output of each attention module based on the toned local feature values and the toned global feature values, and adding the input of each attention module and the output of each attention module as an input of a next attention module; and
adding an input and an output of a last attention module as the third target image data.

6. The method according to claim 5, wherein toning the local feature values and the global feature values comprises:
acquiring illuminance feature values corresponding to the input of each attention module;
subtracting the illuminance feature values from the local feature values to obtain the toned feature values; and
subtracting the illuminance feature values from the global feature values to obtain the toned global feature values.

7. The method according to claim 5, wherein acquiring an output of each attention module based on the toned local feature values and the toned global feature values comprises:
connecting the toned local feature values and the toned global feature values in series to obtain merged features;
performing feature extraction and feature enhancement on the merged features to obtain fourth target image data; and
adding the fourth target image data with the input of each attention module as the output of each attention module.

8. The method according to claim 2, wherein preprocessing the original image data comprises:
sampling pixels corresponding to a target color channel from the original image data, and filling rest unsampled pixels with filling values to obtain a sampling result corresponding to the target color channel.

9. The method according to any one of claim 2, wherein the image conversion model comprises at least one attention module; extracting local feature values and global feature values based on the first target image data, tone mapping the local feature values and the global feature values, and acquiring target image data corresponding to the original image data based on the tone-mapping local feature values and the tone-mapping global feature values, comprising:
acquiring second target image data based on the first target image data;
extracting local feature values and global feature values from the second target image data by using the at least one attention module, tone mapping the local feature values and the global feature values, and acquiring third target image data based on the tone-mapping local feature values and the tone-mapping global feature values;
acquiring the target image data corresponding to the original image data based on the third target image data.

10. The method according to any one of claim 3, wherein the image conversion model comprises at least one attention module; extracting local feature values and global feature values based on the first target image data, tone mapping the local feature values and the global feature values, and acquiring target image data corresponding to the original image data based on the tone-mapping local feature values and the tone-mapping global feature values, comprising:
acquiring second target image data based on the first target image data;
extracting local feature values and global feature values from the second target image data by using the at least one attention module, tone mapping the local feature values and the global feature values, and acquiring third target image data based on the tone-mapping local feature values and the tone-mapping global feature values;
acquiring the target image data corresponding to the original image data based on the third target image data.

11. The method according to any one of claim 3, wherein the method further comprises: stacking the sampling result corresponding to each color channel.

12. An image conversion model comprising a processing module;
the processing module, configured to extract local feature values and global feature values based on first target image data, toning the local feature values and the global feature values, and acquiring target image data corresponding to the original image data based on the toned local feature values and the toned global feature values;
wherein the first target image data is obtained by preprocessing the original image data.

13. A model training method, comprising:
acquiring a training sample, wherein the training sample comprises an original image data sample and a target image data sample corresponding to the original image data sample; and
training an image conversion model to be trained by using the training sample, calculating a plurality of loss functions of the image conversion model to be trained, and calculating a comprehensive loss function of the image conversion model to be trained based on the plurality of loss functions; obtaining a trained image conversion model when the comprehensive loss function meets a preset condition.

14. An electronic device, comprising a processor and a computer-readable storage medium, wherein a computer program is stored on the computer-readable storage medium;
when the computer program is executed by the processor, it causes the processor to execute the image processing method according to claim 1.

15. A computer-readable storage medium, wherein a computer program is stored on the computer-readable storage medium, which, when executed by a processor, causes the processor to execute the image processing method according to claim 1.

16. The image conversion model according to claim 8, wherein the image conversion model further comprises: an input module, stacked at least one residual multi-frequency attention (RMFA) module and an output module.

17. The image conversion model according to claim 16, wherein a second target image data is acquired in the input module based on the first target image data, and an output of the input module is the second target image data.

18. The image conversion model according to claim 16, wherein an input of a first RMFA module is the second target image data, an output and an input of a previous RMFA module are added as an input of a next attention module, and an input and an output of a last attention module are added as an input of the output module.

19. The image conversion model according to claim 16, the processing module further configured to use the stacked at least one RMFA module, extract local feature values and global feature values from the second target image data, perform tone mapping the local feature values and the global feature values, and acquire a third target image data based on the tone-mapping local feature values and the tone-mapping global feature values.

20. The image conversion model according to claim 19, wherein the input of the output module is the third target image data, and the output module is configured to use a convolution layer and a sigmoid activation function to process the third target image data, to obtain RGB image data corresponding to the original image data based on the third target image data.
